(19) United States
(12) Patent Application Publication
(10) Pub. No.: US 2009/0303526 A1
(43) Pub. Date: Dec. 10, 2009

(54) DOCUMENT DATA UPDATE INFORMATION CREATION PROCESSING SYSTEM, IMAGE FORMING APPARATUS, DOCUMENT DATA UPDATE INFORMATION CREATION PROCESSING METHOD, AND RECORDING MEDIUM

(75) Inventors: Minako Kobayashi, Ikeda-shi (JP); Takehisa Yamaguchi, Ikoma-shi (JP); Katsuhiko Akita, Amagasaki-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/359,769

(22) Filed: Jan. 26, 2009

(30) Foreign Application Priority Data
Jun. 6, 2008 (JP) 2008-149980

(51) Int. Cl. G06F 3/12

(52) U.S. Cl. 358/1.15; 358/1.1

(57) ABSTRACT

A document data update information providing system has a document data accumulation apparatus and an image forming apparatus interconnected via a network. The document data accumulation apparatus creates update information of document data selectively among those accumulated in the document data accumulation apparatus, by an update information creator. The image forming apparatus transmits a request for update information of document data, thereby obtains the selectively created update information and displays it on a display.

This application claims priority under 35 U.S.C. §119 to Japanese Patent Application No. 2008-149980 filed on Jun. 6, 2008, the entire disclosure of which is incorporated herein by reference in its entirety.

### BACKGROUND OF THE INVENTION

1. Field of the Invention

The present invention relates to a document data update information creation processing system having an image forming apparatus and a document data accumulation apparatus interconnected via a network, the image forming apparatus, a document data update information creation processing method, and a computer readable recording medium having a document data update information creation processing program recorded therein to make a computer execute processing.

2. Description of the Related Art

The following description sets forth the inventor's knowledge of related art and problems therein and should not be construed as an admission of knowledge in the prior art.

In recent years, it has become possible that an image forming apparatus such as a MFP (Multi Function Peripheral) that is a multifunctional digital machine obtains document data among those accumulated in a server connected thereto via a network, by using WebDAV (Distributed Authoring and Versioning protocol for the WWW), and displays Web pages stored in the server, on its operation panel by a Web browser installed on the image forming apparatus.

However, according to a technology, in which document data is accumulated in a server, an image forming apparatus needs to obtain by accessing the server, update information of document data among those accumulated in the server, in order to display the update information for users. Thus, the image forming apparatus takes a considerable time to obtain and display update information, which is a disadvantage of this technology.

To resolve this disadvantage, there is a technology disclosed in the Japanese Unexamined Laid-open Patent Publication No. H10-326162, and wherein an information record file, and a state record file recording information that is updated in real time on information recorded in the information record file, are recorded in a server, and all the information to be used for a print service, e.g. operation states, can be viewed in real time.

However, according to this technology right above, the server creates update information of the respective document data stored therein, in a single uniform manner. Thus, the server is required to process a large amount of load, which is a disadvantage of this technology. And also, an image forming apparatus takes a considerable time to select preferable update information, which is a disadvantage of this technology.

Another technology, in which document data is accumulated in an image forming apparatus, has the same disadvantages as those described above. In other words, according to this technology, the image forming apparatus creates update information of the respective document data stored therein, in a single uniform manner. Thus, the image forming apparatus is required to process a large amount of load, and takes a considerable time to provide users with update information.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide a document data update information creation processing system that is capable of providing users with update information in an efficient manner, without the need of processing a large amount of load to create the update information.

It is another object of the present invention to provide an image forming apparatus that is preferably employed in the document data update information creation processing system.

It is another object of the present invention to provide a document data update information creation processing method that is capable of providing users with update information in an efficient manner, without the need of processing a large amount of load to execute the update information.

It is another object of the present invention to provide a computer readable recording medium that has a document data update information creation processing program recorded thereon to makes a computer execute processing by the document data update information creation processing method.

According to a first aspect of the present invention, a document data update information creation processing system has a document data accumulation apparatus and an image forming apparatus interconnected via a network, and the document data accumulation apparatus includes:
an accumulator that accumulates in itself document data;
an update information creator that creates update information of document data selectively among those accumulated in the accumulator; and
a transmitter that transmits the update information created by the update information creator, in response to a request received from the image forming apparatus, and
   the image forming apparatus includes:
a requester that transmits a request for the update information to the document data accumulation apparatus;
a receiver that receives the update information that is transmitted from the document data accumulation apparatus in response to the request transmitted by the requester;
a display that is capable of displaying on itself the update information received by the receiver.

According to a second aspect of the present invention, an image forming apparatus includes:
an accumulator that accumulates in itself document data;
a update information creator that creates update information of document data selectively among those accumulated in the accumulator; and
a display that is capable of displaying on itself the update information created by the update information creator.

According to a third aspect of the present invention, a document data update information creation processing system has a document data accumulation apparatus and a plurality of image forming apparatuses interconnected via a network, and the document data accumulation apparatus includes:
an accumulator that accumulates in itself document data;
an update information creator that creates update information of the document data accumulated in the accumulator; and
a transmitter that transmits the update information created by the update information creator, in response to a request received from the image forming apparatuses, and
   each of the image forming apparatuses includes:
a requester that transmits a request for update information of document data to the document data accumulation apparatus, with a frequency level that is changed according to the document data;
a receiver that receives the update information that is transmitted from the document data accumulation apparatus in response to the request transmitted by the requester; and
a display that is capable of displaying on itself the update information received by the receiver.

According to a fourth aspect of the present invention, a document data update information creation processing method of a document data update information processing system having a document data accumulation apparatus and an image processing apparatus interconnected via a network, includes:
accumulating document data in the document data accumulation apparatus;
creating update information of document data selectively among those accumulated therein, by the document data accumulation apparatus;
transmitting the created update information by the document data accumulation apparatus, in response to a request received from the image forming apparatus;
transmitting a request for update information of document data by the image forming apparatus; and
receiving the update information that is transmitted by the document data accumulation apparatus in response to the request; and
displaying the received update information on a display.

According to a fifth aspect of the present invention, a document data update information creation processing method of an image forming apparatus includes:
accumulating document data;
creating update information of document data selectively among the accumulated document data; and
displaying the created update information on a display.

According to a sixth aspect of the present invention, a document data update information creation processing method of a document data update information creation processing system having a plurality of document data accumulation apparatuses and an image forming apparatus interconnected via a network, includes:
accumulating document data in the document data accumulation apparatuses;
creating by the document data accumulation apparatuses, update information of document data among their document data accumulated therein, respectively by taking their own partial charges;
transmitting the created update information by the document data accumulation apparatuses, in response to a request received from the image forming apparatus;
transmitting a request for update information of document data to the document data accumulation apparatuses, by the image forming apparatus, with a priority level that is changed according to the document data;
receiving the update information that is transmitted by the document data accumulation apparatuses in response to the request; and
displaying the received update information on a display.

According to a seventh aspect of the present invention, a computer readable recording medium has a document data update information creation processing program recorded therein to make a computer of an image forming apparatus execute:
accumulating document data;
creating update information of document data selectively among the accumulated document data; and
displaying the created update information on a display.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a view schematically showing a configuration of a document data update information creation processing system according to one embodiment of the present invention;

FIG. 2 is a block diagram showing a functional configuration of an image forming apparatus employed in the system shown in FIG. 1;

FIG. 3 is a block diagram showing a functional configuration of a document data accumulation apparatus employed in the system shown in FIG. 1;

FIG. 4 is a view showing an example of update information;

FIG. 5 is a plain view of an operation panel of the image forming apparatus;

FIG. 6 is a flowchart representing a priority level setting procedure executed if the document data accumulation apparatus creates update information;

FIG. 7 is a flowchart representing a procedure executed in the image forming apparatus, to obtain update information created by the document data accumulation apparatus;

FIG. 8 relates to another embodiment of the present invention, and is a view showing an example of update information created by the image forming apparatus;

FIG. 9 is a flowchart representing a priority level setting procedure executed if the image forming apparatus creates update information;

FIG. 10 relates to yet another embodiment of the present invention, and is a view schematically showing a configuration of a document data update information creation processing system, in which a RSS server creates update information; and

FIG. 11 relates to still yet another embodiment of the present invention, and is a view schematically showing a configuration of a document data update information creation processing system, in which the image forming apparatus creates update information by using RSS.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

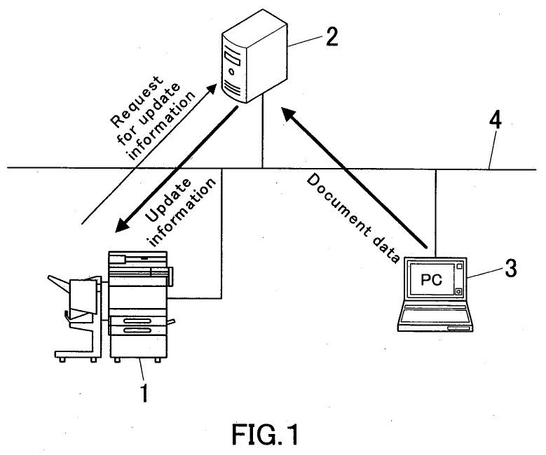

FIG. 1 is a view schematically showing a configuration of a document data update information creation processing system according to one embodiment of the present invention.

As shown in FIG. 1, this document data update information creation processing system includes an image forming apparatus 1, a server 2 just as an example of a document data accumulation apparatus, and a personal computer (hereinafter will be referred to as “PC”) 3 just as an example of a user terminal. The image forming apparatus 1, the server 2 and the PC 3 are interconnected via a network 4.

In this document data update information creation processing system, the PC 3 transmits document data to the server 2, and the server 2 accumulates in itself the document data received therefrom, and then the server 2 creates update information of document data selectively among those accumulated therein. And in response to a request for update information from the image forming apparatus 1, the server 2 transmits the created update information to the image forming apparatus 1.

In this embodiment, a MFP that is a multifunctional digital machine having a plurality of functions such as the copy function, the print function and the facsimile function, is employed as the image forming apparatus 1. The image forming apparatus 1 obtains update information created by the server 2 and updates the displayed contents based on the update information, then executes a job such as a print job to print out document data.

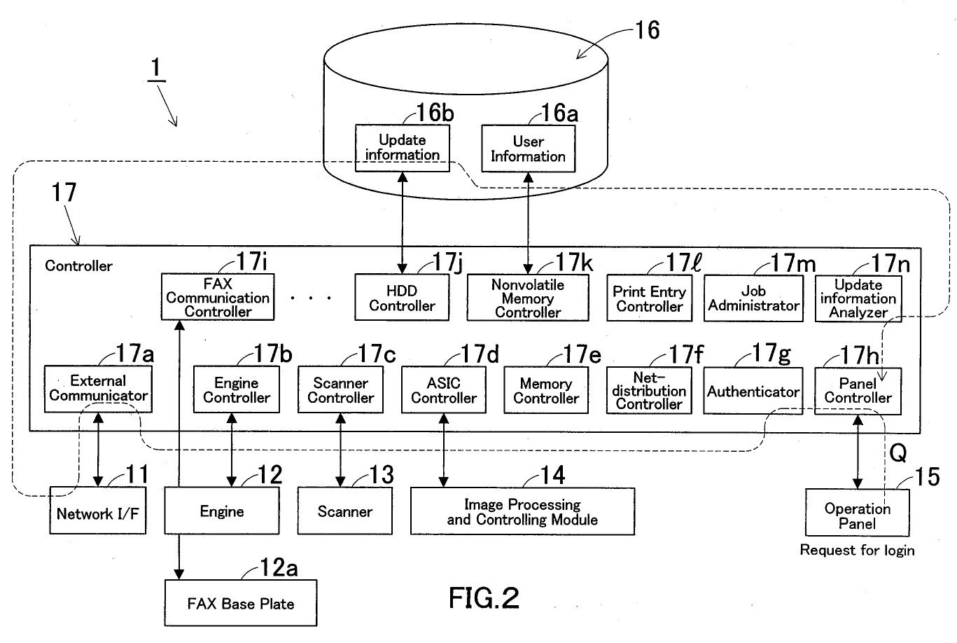

FIG. 2 is a block diagrams showing a functional configuration of the image forming apparatus 1.

As shown in FIG. 2, this image forming apparatus 1 includes a network interface (network I/F) 11, an engine 12, a scanner 13, an image processing and controlling module 14, an operation panel 15, a memory 16, a controller 17 and etc.

The network interface 11 serves to communicate with the server 2 and the PC 3, via the network 4.

The engine 12 is a printer that prints out document data and etc., and has a FAX base plate 12a connected thereto.

The scanner 13 reads an image on a document placed on a document table.

The image processing and controlling module 14 performs image processing in a predetermined manner, before the image data read out by the scanner 13 is printed out.

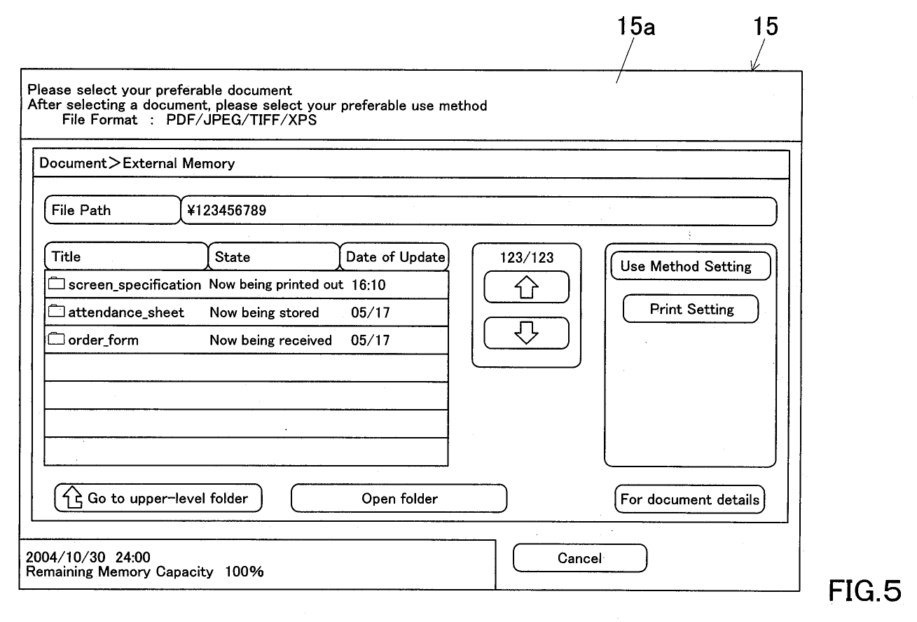

The operation panel 15 includes a key entry portion (not shown in Figs) consisting of numeric keys, a start key and other keys, and a display 15a (shown in FIG. 5) that is a liquid crystal display with touch-panel functionality, for example. The operation panel 15 is used by users to perform a login operation, various entry operations and other operations, and is capable of displaying on the display 15a, update information obtained from the server 2.

The memory 16 includes a nonvolatile memory 16a that records in itself user information, and a hard disk drive (HDD) 16b that records in itself update information of document data, and others. Update information of document data may be recorded for respective users. The hard disk drive 16b has Boxes that are a plurality of memory areas created therein, for example, personal Boxes owned by respective users, group Boxes shared with members of same groups, and shared Boxes that can be accessed by unspecified users.

The controller 17 includes an external communicator 17a that is capable of communicating with external devices on the network 4 via the network interface 11, an engine controller 17b, a scanner controller 17c, an ASIC (Application Specific Integrated Circuit) controller 17d that controls the image processing and controlling module 14, a memory controller 17e, an net-distribution controller 17f, an authenticator 17g that authenticates users trying to log in, a panel controller 17h that controls the operation panel 15, a FAX communication controller 17i that controls operations to exchange document data and etc. by FAX, a HDD controller 17j that controls the HDD 16b, a nonvolatile memory controller 17k that controls the nonvolatile memory 16a, a print entry controller 17l, a job administrator 17m, and an update information analyzer 17n that performs analysis by comparing information before and after update thereof and other operations, when update information of document data is obtained from the server 2. The controller 17 includes a CPU, a ROM, a RAM and etc. not shown in Figs.

When a user logs in the image forming apparatus 1 and issues an instruction to obtain update information of document data by using the operation panel 15, information of this instruction is transmitted to the server 2 on the network 4, by way of the panel controller 17h, the external communicator 17a and the network interface 11. In return, update information created by the server 2 is obtained via the network 4. The obtained update information is recorded in the HDD 16b and analyzed by the update information analyzer 17n, then displayed on the display 15a of the operation panel 15.

The server 2 is a webDAV server for example, and accumulates in itself document data according to an instruction received from the PC 3 that is a user terminal, and creates update information of document data selectively among those accumulated therein.

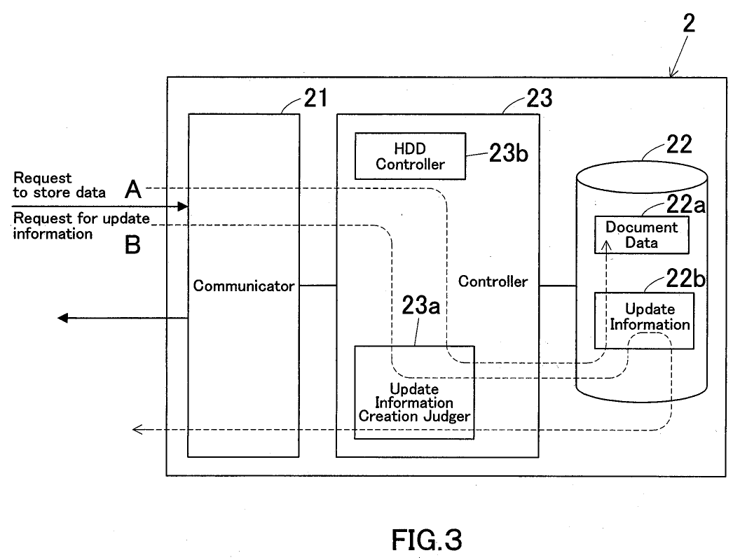

FIG. 3 is a block diagram showing a functional configuration of the server 2.

As shown in FIG. 3, the server 2 includes a communicator 21, a memory 22 and a controller 23.

The communicator 21 serves to exchange document data and etc. with external devices on the network, which are the image forming apparatus 1 and the PC 3.

The memory 22 is a hard disk drive (HDD) for example, and it includes a document data memory 22a that accumulates in itself document data and an update information memory 22b that records in itself update information of the document data. The document data memory 22a has a plurality of memory areas (Boxes). The Boxes include personal Boxes owned by respective users, group Boxes shared with members of same groups, and shared Boxes that can be accessed by unspecified users.

The controller 23 includes an update information creation judger 23a and a HDD controller 23b. The update information creation judger 23a creates update information of document data selectively among those accumulated, according to a set condition. The HDD controller 23b controls the memory 22. This controller 23 includes a CPU, a ROM, a RAM and etc. not shown in Figs.

When the PC 3 transmits to the server 2 a request to store document data, the document data is received by the communicator 21 and routed through the update information creation judger 23a of the controller 23, then stored in the document data memory 22a of the memory 22, as indicated by a dashed line A in FIG. 3.

When the image forming apparatus 1 transmits to the server 2 a request to provide update information, the request is received by the communicator 21, and update information recorded in the update information memory 22a is transmitted to the image forming apparatus 1, as indicated by a dashed line B in FIG. 3.

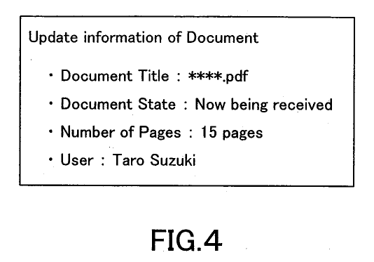

FIG. 4 shows an example of update information. According to FIG. 4, update information of the document data owned by the user “Taro Suzuki” indicates the current state of the document data as “now being received”, and the document data that is now being received consists of “15” pages.

Hereinafter, the update information creation process performed in this document data update information creation processing system will be explained briefly.

(1) A user gives to the server 2 an instruction to store document data, by using the PC 3.

(2) The server 2 receives the accumulator instruction, and at the same time, creates update information thereof before storing the document data.

### <<Examples of Condition Used For Creation of Update Information>>

(2-a) Create update information according to a type of the document data to be stored

If the document data to be stored is accompanied with a print instruction issued by the user, update information thereof is created preferentially and frequently. On the other hand, if the document data is not accompanied with a print instruction and was instructed simply to be stored, the following method (2-b) will be employed.

(2-b) Create update information according to an accumulator destination of the document data instructed simply to be stored

If the document data was instructed to be stored in a group Box (document data to be shared with members of a group) or in a shared Box (document data to be shared with unspecified users), update information of the document data is created more preferentially from that of document data instructed to be stored in a personal Box (document data owned by respective users). If the document data was instructed to be stored in a personal Box (document data owned by respective users), the following method (2-c) will be employed.

(2-c) Create update information according to an attribute of the user

The priority level for creation of update information is changed according to an attribute of the user, for example his/her business title. Basically, a higher priority level is given to a user who needs higher security.

(2-d) Create update information according to an operating state

If a user is already logged in the image forming apparatus 1 when an error happens to the server 2, update information is created frequently, since he/she is likely waiting by the side of the image forming apparatus 1.

(2-e) Create update information according to a user instruction

The priority level and the frequency level for creation of update information may be set in advance, and may be changed later according to a user instruction.

(3) A user logs in the image forming apparatus 1 by using the operation panel 15 thereof (FIG. 2).

(4) The image forming apparatus 1 transmits a request for update information to the server 2, and thereby can frequently obtain update information of document data selectively among those created by the server 2. The obtained update information is displayed on the display 15a of the operation panel 15 as shown in FIG. 5, thus users can be notified of updated information in real-time.

According to FIG. 5, the document data titled as “screen_specification” is now being printed out, the document data titled as “attendance_sheet” is now being stored, and the document data titled as “order_form” is not being received.

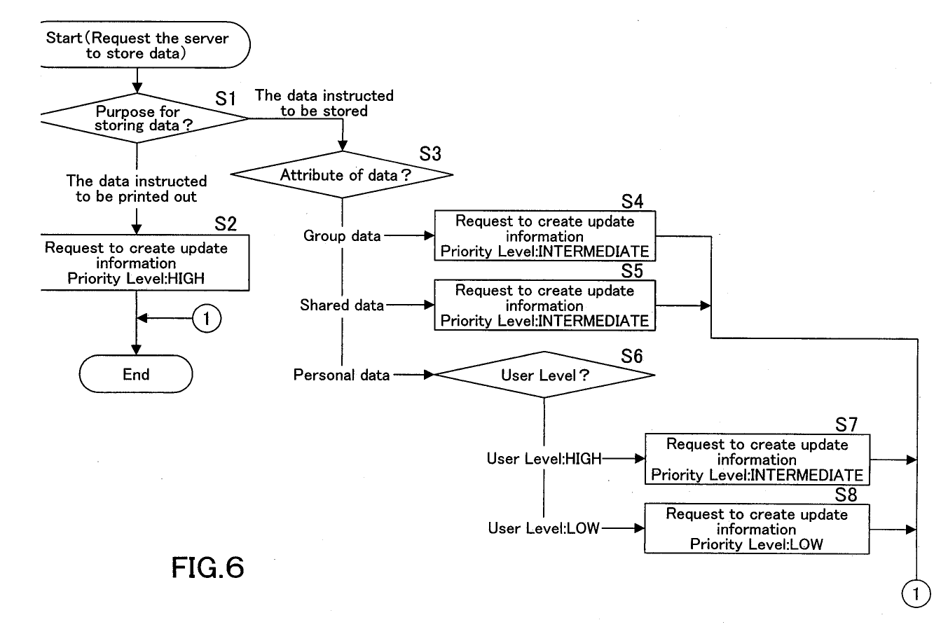

FIG. 6 is a flowchart representing a priority level setting procedure executed if the server 2 creates update information.

As shown in FIG. 6, in Step S1, the purpose for storing the document data is examined, in other words, it is judged that the document data was instructed to be printed out (the document data is accompanied with a print instruction), or alternatively, the document data was instructed simply to be stored. If the document data was instructed to be printed out, the routine proceeds to Step S2. If the document data was instructed simply to be stored, the routine proceeds to Step S3.

In Step S2, the priority level for creation of update information is set to “HIGH” on the document data instructed to be printed out.

In Step S3, an attribute of the document data instructed simply to be stored is examined, in other words, it is judged that the document data corresponds to “group data”, “shared data” or “personal data”.

If the document data corresponds to “group data”, the priority level for creation of update information is set to “INTERMEDIATE” in Step S4. If the document data corresponds to “shared data”, the priority level for creation of update information is set to “INTERMEDIATE” in Step S5. If the document data corresponds to “personal data”, then it is judged in Step S6, whether “HIGH” or “LOW”, the user level (security level of the user) is.

If the user level is “HIGH”, the priority level for creation of update information is set to “INTERMEDIATE”. If the user level is “LOW”, the priority level for creation of update information is set to “LOW”.

With the priority level set in the way above, update information of the document data is created. Examples of the update information created according to the set priority level will be described as the following.

(1) Create update information according to the priority level “HIGH”

Update information is created frequently and specifically, for example as “document data now being received”, “document data now being stored” and “document data now being transmitted”.

(2) Create update information according to the priority level “INTERMEDIATE”

Update information is created not so frequently than the case (1) described above, for example as “document data now being received” and “document data now being transmitted”.

(3) Create update information according to the priority level “LOW”

No update information is created.

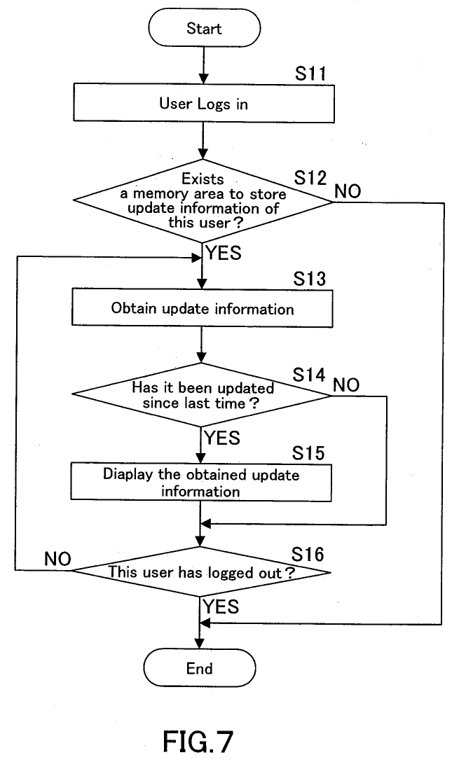

FIG. 7 is a flowchart representing a procedure executed in the image forming apparatus 1, to obtain update information of document data, which is created by the server 2.

As shown in FIG. 7, in Step S11, a user logs in the image forming apparatus 1. And it is judged in Step S12, whether or not there exists a memory area to store update information of this user. If there exists no memory area to store update information of this user (NO in Step S12), the routine immediately terminates. If there exists a memory area to store update information of this user (YES in Step S12), update information is obtained from the server 2 in Step S13.

Then, it is judged in Step S14, whether or not the update information obtained from the server 2 has been updated since the last time. If it has been updated (YES in Step S14), the update information obtained from the server 2 is displayed on the display in Step S15, then the routine proceeds to Step S16. If it has not been updated (NO in Step S14), the routine directly proceeds to Step S16.

In Step S16, it is judged whether or not this user has logged out of the image forming apparatus 1. If he/she has not logged out (NO in Step S16), the routine goes back to Step S13. If he/she has logged out (YES in Step S16), the routine immediately terminates.

As described above in this embodiment, if the server 2 creates update information of document data among those accumulated therein, the priority level for creation of update information is changed according to a set condition. Thus, the server 2 is not required to process such a large amount of load compared to the conventional technology, in which the server 2 creates update information of the respective document data accumulated therein, in a single uniform manner.

Furthermore, in response to a request for update information of document data from the image forming apparatus 1, it can be provided thereto in an efficient manner.

Furthermore, if the document data is accompanied with a print instruction issued by a user, update information of the document data is created preferentially and frequently, since the user will come to the image forming apparatus soon. Thus, the update information can be provided to this user preferentially and rapidly.

Furthermore, if the stored document data was instructed simply to be stored, update information of the document data instructed to be stored in a Box that is shared with group members or in a Box that is shared with unspecified users, is created preferentially. Thus, the update information can be provided preferentially with the group members or the unspecified users.

In this embodiment, the server 2 employed in the document data update information creation processing system, creates update information. Alternatively, the image forming apparatus 1 may create update information of document data selectively among those accumulated in the memory 16 of the image forming apparatus 1. More specifically, the controller 17 may create update information thereof.

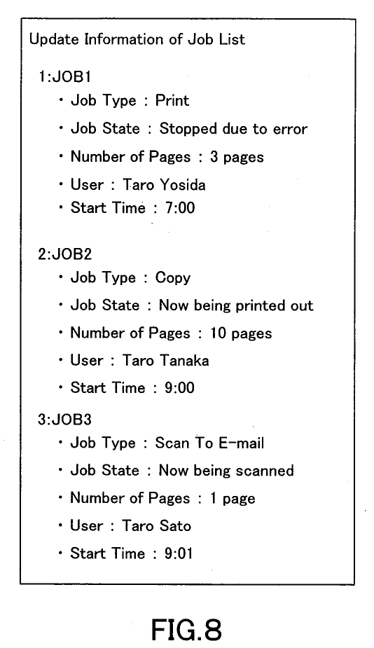

FIG. 8 shows an example of update information created by the image forming apparatus 1. In this example, update information corresponds to a job list that details states of jobs executed on document data. Alternatively, update information may correspond to a list of the document data accumulated in a Box of the memory 16 (a list of Box documents).

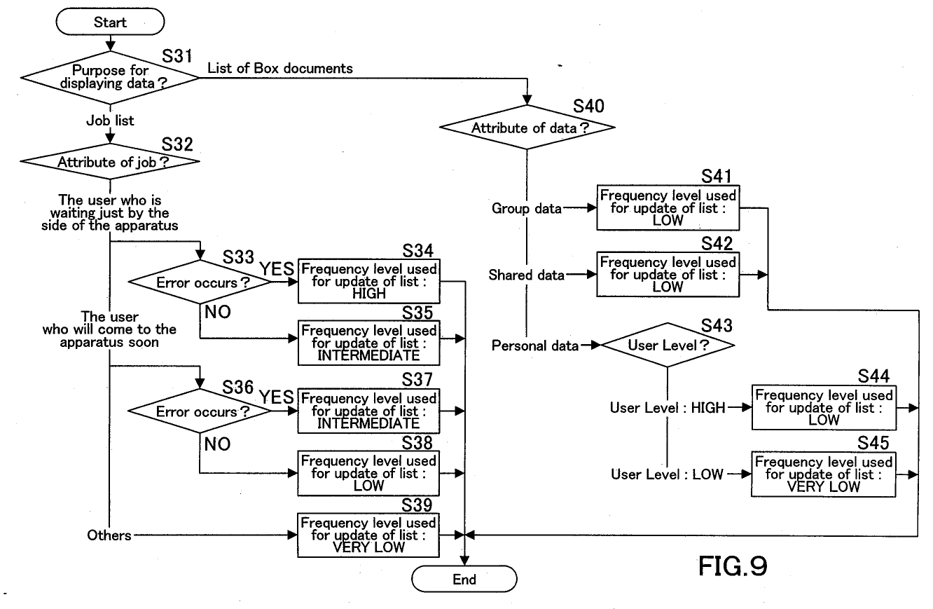

FIG. 9 is a flowchart representing a priority level setting procedure executed if the image forming apparatus 1 creates update information. This procedure is executed by the CPU of the controller 17, according to a program recorded in a recording medium such as the ROM or the memory 16.

As shown in FIG. 9, in Step S31, the purpose for displaying is examined, in other words, it is judged which was instructed to be displayed by a user, a job list or a list of Box documents. If a job list was instructed to be displayed, the routine proceeds to Step S32. If a list of Box documents was instructed to be displayed, the routine proceeds to Step S40.

In Step S32, an attribute of the job is examined. For example, it is judged to which the job relates, the user who is waiting by the side of the image forming apparatus 1, in other words, the document data is now being copied (copy job) or now being readout from a document for scan transmission (scan transmission job) or facsimile transmission (facsimile transmission job); the user who will come to the image forming apparatus 1 soon, in other words, the document data is now being printed out (PC print job) or now being transmitted for scan-transmission (scan transmission job) or facsimile-transmission (facsimile transmission job); or other than those above.

If the job relates to the user who is waiting by the side of the image forming apparatus 1, then it is judged in Step S33, whether or not an error occurs. If an error occurs (YES in Step S33), the frequency level for update of the job list is set to “HIGH” in Step S34. If no error occurs (NO in Step S33), the frequency level for update of the job list is set to “INTERMEDIATE” in Step S35.

If the job relates to the user who will come to the image forming apparatus 1 soon, then it is judged in Step S36, whether or not an error occurs. If an error occurs (YES in Step S36), the frequency level for update of the job list is set to “INTERMEDIATE” in Step S37. If no error occurs (NO in Step S36), the frequency level for update of the job list is set to “LOW” in Step S38.

If the job relates to other than those above, the frequency level for update of the job list is set to “VERY LOW” in Step S39.

Meanwhile, if a list of Box documents was instructed to be displayed, then in Step S40, an attribute of the document data is examined, in other words, according to the Box that stores the document data, it is judged that the document data corresponds to group document data stored in a group Box, shared document data stored in a shared Box, or personal document data stored in a personal Box.

If it corresponds to group document data, the frequency level for update of the list of Box documents is set to “LOW” in Step S41. If it corresponds to shared document data, the frequency level for update of the list of Box documents is set to “LOW” in Step S42. If it corresponds to personal document data, then it is judged in Step S43, whether “HIGH” or “LOW”, the user level (security level of the user) is.

If the user level is “HIGH”, the frequency level for update of the list of Box documents is set to “LOW”. If the user level is “LOW”, the frequency level for update of the list of Box documents is set to “VERY LOW”.

With the update frequency level set in the way above, the job list or the list of Box documents is updated.

As described above in this embodiment, if the image forming apparatus 1 creates update information, update information of a job list that is more useful for users, is created more frequently than that of a list of Box documents. Furthermore, even if an error occurs during execution of a job related to the user who needs to stand by the side of the image forming apparatus 1, update information thereof, which is updated frequently, can be provided to this user rapidly. This would contribute to the user convenience.

Alternatively, users may be allowed to specify the priority level and the frequency level for creation of update information of document data. For example, users may configure such that update information of a list of Box documents is created more preferentially from that of a job list.

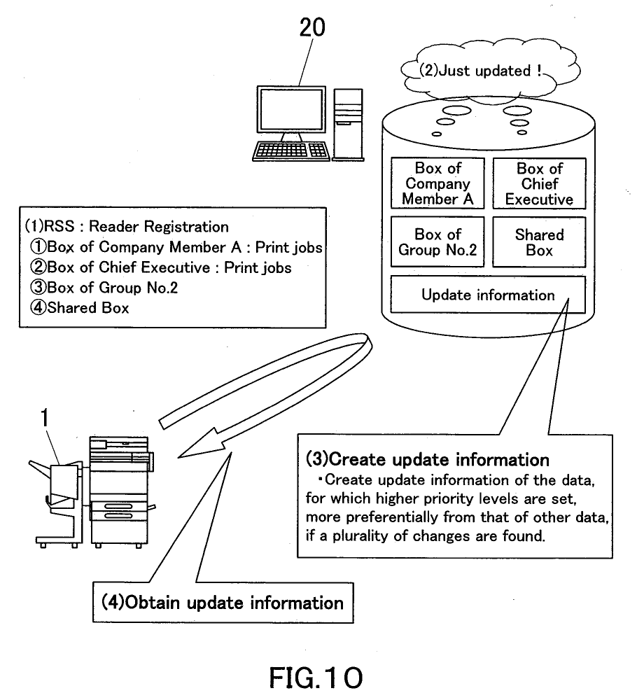

FIG. 10 shows another embodiment of the present invention. According to this embodiment, it is a view schematically showing a document data update information creation processing system, in which a RSS (RDF Site Summary) server 20 creates update information of document data selectively among those accumulated therein.

As shown in FIG. 10, the RSS server 20 has a personal Box of company member A, a personal Box of Chief Executive, a group Box of Group No. 2, and a shared Box, and update information of document data is created with a priority level and a frequency level preliminarily set for each of the Boxes accumulating the document data. For example, the priority level for creation of update information is set to “HIGH” on the print jobs accumulated in the personal Box of company member A and in the personal Box of Chief Executive, meanwhile the priority level for creation of update information is set to “INTERMEDIATE” or “LOW” on the document data stored in the group Box of Group No. 2 and in the shared Box.

The image forming apparatus 1 obtains usually by making the rounds, update information of the print jobs and the document data stored in (1) the personal Box of company member A, (2) the personal Box of Chief Executive, (3) the group Box of Group No. 2, and (4) the shared Box, in a manner registered in advance. And if the update information has been updated since the last time, it is displayed on the display 15a.

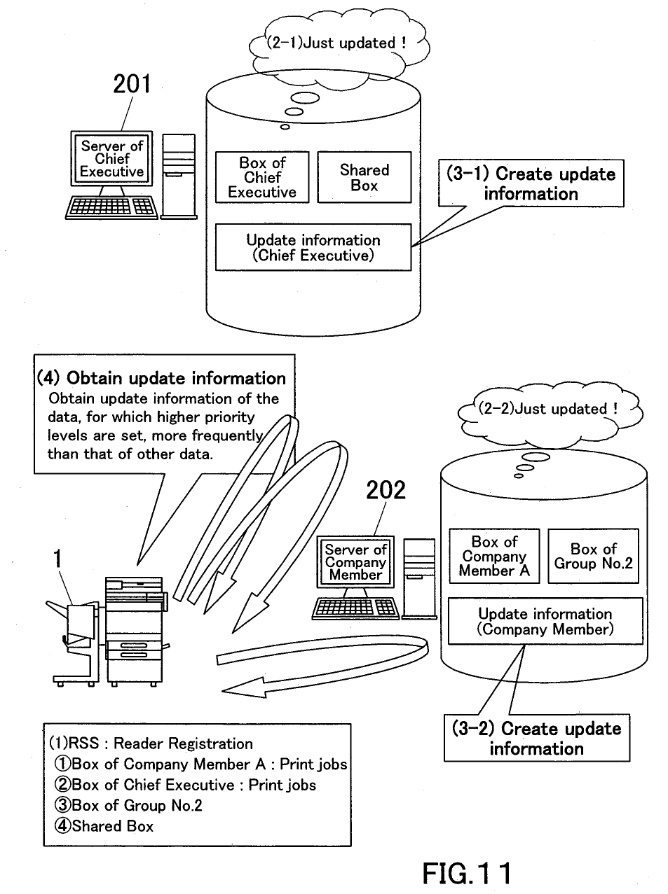

FIG. 11 is a view schematically showing a configuration of a document data update information creation processing system, in which a plurality of RSS servers, i.e. servers 201 and 202 create update information of their document data accumulated therein, respectively by taking their own partial charges, and the frequency level for obtaining update information, which is set on the image forming apparatus 1, is changed. In this system, the image forming apparatus 1 functions as if it creates update information of document data selectively among those accumulated therein.

As shown in FIG. 11, the two RSS servers, i.e. the server 201 and the server 202 are provided for Chief Executive and company member A, respectively.

The RSS server 201 has a personal Box of Chief Executive and a shared Box, and update information of document data is created in a single uniform manner determined for each of the Boxes accumulating the document data. And the RSS server 202 has a personal Box of company member A and a group Box of Group No. 2, and update information of document data is created in a single uniform manner determined for each of the Boxes accumulating the document data. In this way, these two servers create update information of their document data accumulated therein, respectively by taking their own partial roles, which does not require the respective servers to process such a large amount of load compared to the conventional technology, in which one server creates update information of as much amount of load as all the document data accumulated in these two servers.

On the other hand, the image forming apparatus 1 obtains by making the rounds, update information of (1) company member A: print jobs, (2) chief executive: print jobs, (3) the group Box of Group No. 2 and (4) the shared Box, registered in advance. Meanwhile, the frequency level for obtaining update information, which is set on the image forming apparatus 1 for (1) company member A: print jobs and (2) chief executive: print jobs, is higher than that set thereon for (3) the group Box of Group No. 2 and (4) the shared Box. And thus, the image forming apparatus 1 obtains update information of the print jobs preferentially. As a result, the image forming apparatus 1 functions as if it creates update information of document data selectively among the accumulated document data.

And, if the obtained update information has been updated since the last time, it is displayed on the display 15a of the operation panel 15.

As described above in this embodiment, the image forming apparatus 1 transmits to the servers 201 and 202, a request for update information of document data with a frequency level that is changed according to the document data. And thus, users can view necessary update information displayed on the display, in an efficient manner without taking time to select it.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. A document data update information creation processing system having a document data accumulation apparatus and an image forming apparatus interconnected via a network, wherein:
the document data accumulation apparatus comprises:
an accumulator that accumulates in itself document data;
an update information creator that creates update information of document data selectively among those accumulated in the accumulator; and
a transmitter that transmits the update information created by the update information creator, in response to a request received from the image forming apparatus, and
the image forming apparatus comprises:
a requester that transmits a request for the update information to the document data accumulation apparatus;
a receiver that receives the update information that is transmitted from the document data accumulation apparatus in response to the request transmitted by the requester;
a display that is capable of displaying on itself the update information received by the receiver.

2. The document data update information creation processing system recited in claim 1, wherein:
the update information creator changes the priority level for creation of update information, according to a set condition.

3. The document data update information creation processing system recited in claim 2, wherein:
the update information creator preferentially and frequently creates update information of document data among those accumulated in the accumulator, if the document data is accompanied with a print instruction issued by a user.

4. The document data update information creation processing system recited in claim 2, wherein:
the update information creator preferentially creates update information of document data shared with group members or unspecified users, among those accumulated in the accumulator, if the document data is not accompanied with a print instruction issued by a user.

5. An image forming apparatus comprising:
an accumulator that accumulates in itself document data;
a update information creator that creates update information of document data selectively among those accumulated in the accumulator; and
a display that is capable of displaying on itself the update information created by the update information creator.

6. The image forming apparatus recited in claim 5, wherein:
the update information creator changes the priority level for creation of update information, according to a set condition.

7. The image forming apparatus recited in claim 6, wherein:
the update information creator creates update information of a list of states of running jobs related to the document data accumulated in the accumulator, more preferentially from that of a list of the document data accumulated in the accumulator.

8. A document data update information creation processing system having a document data accumulation apparatus and a plurality of image forming apparatuses interconnected via a network, wherein:
the document data accumulation apparatus comprises:
an accumulator that accumulates in itself document data;
an update information creator that creates update information of the document data accumulated in the accumulator; and
a transmitter that transmits the update information created by the update information creator, in response to a request received from the image forming apparatuses, and
each of the image forming apparatuses comprises:
a requester that transmits a request for update information of document data to the document data accumulation apparatus, with a frequency level that is changed according to the document data;
a receiver that receives the update information that is transmitted from the document data accumulation apparatus in response to the request transmitted by the requester; and
a display that is capable of displaying on itself the update information received by the receiver.

9. A document data update information creation processing method of a document data update information processing system having a document data accumulation apparatus and an image processing apparatus interconnected via a network, comprising:
accumulating document data in the document data accumulation apparatus;
creating update information of document data selectively among those accumulated therein, by the document data accumulation apparatus;
transmitting the created update information by the document data accumulation apparatus, in response to a request received from the image forming apparatus;
transmitting a request for update information of document data by the image forming apparatus; and
receiving the update information that is transmitted by the document data accumulation apparatus in response to the request; and
displaying the received update information on a display.

10. The document data update information creation processing method recited in claim 9, wherein:
when update information is created, the priority level for creation of update information is changed, according to a set condition.

11. The document data update information creation processing method recited in claim 10, wherein:
update information of document data among those accumulated therein, is created preferentially and frequently, if the document data is accompanied with a print instruction issued by a user.

12. The document data update information creation processing method recited in claim 10, wherein:
update information of document data shared with group members or unspecified users, among those accumulated therein, is created preferentially, if the document data is not accompanied with a print instruction issued by a user.

13. A document data update information creation processing method of an image forming apparatus, comprising:
accumulating document data;
creating update information of document data selectively among the accumulated document data; and
displaying the created update information on a display.

14. The document data update information creation processing method recited in claim 13, wherein:
when update information is created, the priority level for creation of update information is changed, according to a set condition.

15. The document data update information creation processing method recited in claim 14, wherein:
update information of a list of states of running jobs related to the accumulated document data, is created more preferentially from that of a list of the accumulated document data.

16. A document data update information creation processing method of a document data update information creation processing system having a plurality of document data accumulation apparatuses and an image forming apparatus interconnected via a network, comprising:
accumulating document data in the document data accumulation apparatuses;
creating by the document data accumulation apparatuses, update information of document data among their document data accumulated therein, respectively by taking their own partial charges;
transmitting the created update information by the document data accumulation apparatuses, in response to a request received from the image forming apparatus;
transmitting a request for update information of document data to the document data accumulation apparatuses, by the image forming apparatus, with a priority level that is changed according to the document data;
receiving the update information that is transmitted by the document data accumulation apparatuses in response to the request; and
displaying the received update information on a display.

17. A computer readable recording medium having a document data update information creation processing program recorded therein to make a computer of an image forming apparatus execute:
accumulating document data;
creating update information of document data selectively among the accumulated document data; and
displaying the created update information on a display.
